(19) United States
(12) Patent Application Publication
(10) Pub. No.: US 2023/0161931 A1
(43) Pub. Date: May 25, 2023

(54) SIMULATION DEVICE AND METHOD OF CONTROLLING THE SAME

(71) Applicants: Hyundai Motor Company, Seoul (KR); Kia Corporation, Seoul (KR)

(72) Inventor: Seung Yong Kwak, Anyang (KR)

(73) Assignees: Hyundai Motor Company, Seoul (KR); Kia Corporation, Seoul (KR)

(21) Appl. No.: 17/962,930

(22) Filed: Oct. 10, 2022

(30) Foreign Application Priority Data
Nov. 24, 2021 (KR) 10-2021-0163134

(51) Int. Cl. G06F 30/20; G06F 30/15

(52) U.S. Cl. CPC G06F 30/20; G06F 30/15

(57) ABSTRACT

Provided is a hardware in the loop simulation (HILS) module comprising an electronic control unit (ECU), a storage configured to store software in the loop simulation (SILS) software comprising a virtual ECU, and a controller configured to control at least one of the HILS module or the SILS software to perform a simulation on a network comprising at least one of the ECU or the virtual ECU.

### CROSS-REFERENCE TO RELATED APPLICATION(S)

This application claims, under 35 U.S.C. § 119(a), the benefit of Korean Patent Application No. 10-2021-0163134, filed on Nov. 24, 2021 in the Korean Intellectual Property Office, the disclosure of which is herein incorporated herein by reference in its entirety.

### BACKGROUND

### Technical Field

Embodiments of the present disclosure relate to a simulation device capable of simulating an electronic control unit (ECU) installed in a vehicle, and a method of controlling the same.

### Description of the Related Art

Recently, vehicles have been equipped with electronic control units (ECUs) configured to control various components of the vehicles. The ECU performs an important function of controlling the operation of the vehicle.

Accordingly, a hardware error or software error of the ECU may lead to an accident of the vehicle. In order to prevent accidents caused by errors in the ECU, ECUs may be subject to simulations in the design stage of the vehicle.

In general, simulations may be performed using a hardware in the loop simulation (HILS) module that provides a test environment using a physical ECU and a control target load of the ECU, or software in the loop simulation (SILS) software that provides a test environment on software using a virtual ECU.

### SUMMARY

It is an object of the disclosure to provide a simulation device and a method of controlling the same that are capable of performing simulation by interworking a hardware in the loop simulation (HILS) module using one or more physical electronic control units (ECUs) and software in the loop simulation (SILS) software using one or more virtual ECUs, so that control function verification of a vehicle system level may be flexibility performed, and the time to be taken for verification environment establishment and evaluation may be reduced.

The technical objectives of the disclosure are not limited to the above, and other objectives may become apparent to those of ordinary skill in the art based on the following descriptions.

According to an aspect of the disclosure, there is provided a simulation device including: a hardware in the loop simulation (HILS) module comprising one or more electronic control units (ECUs); a storage configured to store a software in the loop simulation (SILS) software comprising one or more virtual ECUs; and a controller configured to control one or more of the following: the HILS module; and the SILS software, in order to perform a simulation on a network comprising at least one of the ECU or the virtual ECU.

The simulation device may further comprise a communication interface configured to perform communication between the HILS module and the SILS software.

The simulation device may further comprise a signal generator configured to generate an electrical signal based on a virtual output of a virtual ECU, of the one or more virtual ECUs, and transmit the electrical signal to an ECU, of the one or more ECUs.

The controller may be further configured to configure a network in which at least one of the ECUs is replaced with a virtual ECU, of the one or more virtual ECUs, using the communication interface, and control both the HILS module and the SILS software to perform a simulation on the configured network.

The controller may be further configured to control the HILS module to turn on power of an ECU included in the configured network, among the one or more ECUs, and control the SILS software to turn on a switch of a virtual ECU included in the configured network, among the one or more virtual ECUs.

The simulation device may further comprise an inputter configured to receive a user input, wherein the controller may be further configured to configure a network based on the user input received through the inputter.

The controller may further be configured to, when an input to perform a test on input/output electrical signals of a network is received, control the HILS module to perform a simulation on a network comprising only the one or more ECUs.

The controller may further be configured to, when an input to perform a test on control logics of a network, control the SILS software to perform a simulation on a network comprising only the one or more virtual ECUs.

The controller may further be configured to transmit and receive data to and from the HILS module based on an electrical signal, transmit and receive data to and from the SILS software based on a virtual signal, and determine a result of the simulation based on one or more of the following: at least one of the electrical signal received from the HILS module; and the virtual signal received from the SILS software.

The simulation device may further include a display, wherein the controller may be configured to control the display to display the result of the simulation.

According to an aspect of the disclosure, there is provided a method of controlling a simulation device comprising a hardware in the loop simulation (HILS) module including an electronic control unit (ECU) and a storage configured to store a software in the loop simulation (SILS) software comprising a virtual ECU, the method comprising: controlling one or more of: the HILS module; and the SILS software, in order to perform a simulation on a network comprising one or more of: the ECU; and the virtual ECU.

The simulation device may further comprise a communication interface configured to perform communication between the HILS module and the SILS software.

The simulation device may further comprise a signal generator configured to generate an electrical signal based on a virtual output of the virtual ECU, and transmit the electrical signal to the ECU.

The controlling of the at least one of the HILS module or the SILS software may further comprise: configuring a network in which at least one of the ECUs is replaced with the virtual ECU using the communication interface; and controlling both the HILS module and the SILS software to perform a simulation on the configured network.

The controlling of the at least one of the HILS module or the SILS software may further comprise: controlling the HILS module to turn on power of an ECU included in the configured network among the ECUs; and controlling the SILS software to turn on a switch of a virtual ECU included in the configured network among the virtual ECUs.

The simulation device may further comprise an inputter configured to receive a user input, and the method may further comprise configuring a network based on the user input received through the inputter.

The controlling of the at least one of the HILS module or the SILS software may further comprise, when an input to perform a test on input/output electrical signals of a network is received, controlling the HILS module to perform a simulation on a network comprising only the ECU.

The controlling of the at least one of the HILS module or the SILS software may further comprise, when an input to perform a test on control logics of a network, controlling the SILS software to perform a simulation on a network comprising only the virtual ECU.

The method may further comprise: transmitting and receiving data to and from the HILS module based on an electrical signal; transmitting and receiving data to and from the SILS software based on a virtual signal; and determining a result of the simulation based on at least one of the electrical signal received from the HILS module or the virtual signal received from the SILS software.

The simulation device may comprise a display, and the method may further comprise controlling the display to display the result of the simulation.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram illustrating a simulation device according to an exemplary embodiment;

FIG. 2 illustrates a control flow of the simulation device according to the exemplary embodiment;

FIG. 3 illustrates an example of a configuration of a hardware in the loop simulation (HILS) module and software in the loop simulation (SILS) software according to an exemplary embodiment;

FIG. 4 is a diagram for describing a case in which the simulation device according to the embodiment performs a simulation according to a test scenario;

FIG. 5 illustrates an example of a network when the simulation device according to the embodiment performs SILS-HILS interworking evaluation based on SILS software;

FIG. 6 illustrates an example of a network when the simulation device according to the embodiment performs SILS-HILS interworking evaluation based on a HILS module;

FIG. 7 illustrates a case in which the simulation device according to the embodiment controls a signal generator; and

FIG. 8 is a flowchart showing a case in which a simulation is performed based on a test scenario in a method of controlling a simulation device according to an exemplary embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

It will be further understood that the term “connect” or its derivatives refer both to direct and indirect connection, and the indirect connection includes a connection over a wireless communication network.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

As used herein, the singular forms “a,” “an” and “the” are intended to include the plural forms as well, unless the context clearly indicates otherwise.

The terms, such as “— part”, “—device”, “—block”, “—member”, “— module”, and the like may refer to a unit for processing at least one function or act. For example, the terms may refer to at least process processed by at least one hardware, such as field-programmable gate array (FPGA)/application specific integrated circuit (ASIC), software stored in memories, or processors.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Reference numerals used for method steps are just used for convenience of explanation, but not to limit an order of the steps. Thus, unless the context clearly dictates otherwise, the written order may be practiced otherwise.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Hereinafter, an exemplary embodiment of a simulation device and a method of controlling the same according to an aspect of the present disclosure will be described in detail with reference to the accompanying drawings.

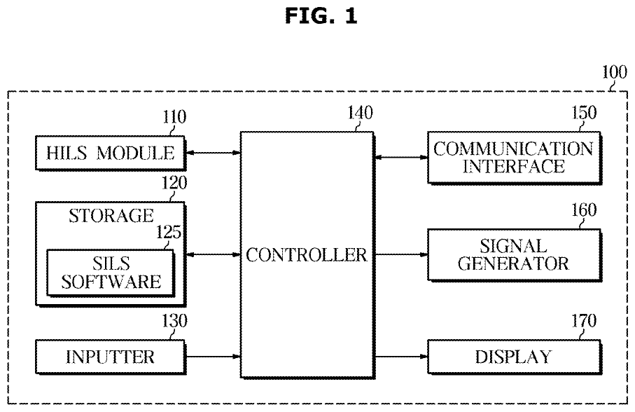

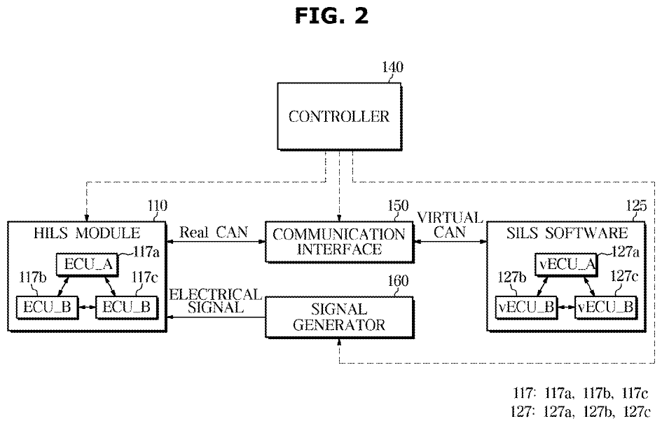

FIG. 1 is a control block diagram illustrating a simulation device according to an exemplary embodiment, and FIG. 2 illustrates a control flow of the simulation device according to the exemplary embodiment.

Referring to FIGS. 1 and 2, a simulation device 100 according to an exemplary embodiment includes a hardware in the A loop simulation (HILS) module 110 configured to perform a simulation using a physical electronic control unit (ECU), a storage 120 configured to store software in the loop simulation (SILS) software for performing a simulation using various types of information required for a simulation and a virtual ECU, an inputter 130 configured to receive a user input, a controller 140 configured to control a simulation using at least one of the HILS module 110 or the SILS software 125, a communication interface 150 configured to perform communication between the HILS module 110 and the SILS software 125, a signal generator 160 configured to provide an electrical signal to the HILS module 110, and a display 170 configured to display a result of the simulation.

Some of the components above described as being included in the simulation device 100 may be omitted depending on embodiments, and components other than the above components may be added according to various embodiments.

The HILS module 110 according to the exemplary embodiment may be configured to perform a simulation using an ECU 117, which is a physical ECU.

The HILS module 110 may include the ECU 117, which is a physical ECU, a plant (not shown) physically connected to the ECU 117 and including an actual load, such as a sensor or actuator, and a simulator (not shown) configured to construct a virtual environment to simulate a real vehicle environment.

The storage 120 according to the exemplary embodiment may be configured to store the SILS software 125 for performing a simulation using various types of information required for a simulation and a virtual ECU 127. To this end, the storage 120 may be provided as a storage medium generally known in the art.

Specifically, the storage 120 may include operating software for a simulation. The operating software may be configured to change a test mode according to a verification scenario, and may include a user interface, auto detection software that automatically implements a verification environment when a network to be verified is configured, and a simulation execution module.

The simulation execution module may be provided as a test framework conforming to the association for standardization of automation and measuring system (ASAM) standard. With such a configuration, the simulation device 100 may be configured to control some or all types of test benches that use the same standard.

In addition, the storage 120 may include an evaluation management module configured for managing simulation results, and the evaluation management module may be configured to manage test case execution logs, measurement data graph information, evaluation results, and the like.

The SILS software 125 may include the virtual ECU 127, and may be configured to perform a simulation using the virtual ECU 127.

Specifically, the SILS software 125 may be configured to reproduce memory operations or interrupt operations of an actual vehicle ECU on a personal computer (PC) to configure the virtual ECU 127.

The SILS software 125 may be configured to implement a virtual network environment using the virtual ECU 127 and may be configured to verify control logics, communication performances, and the like. For example, as shown in FIG. 2, the SILS software 125 may be configured to perform a simulation on a virtual network including three virtual ECUs 127a, 127b, and 127c.

In this case, the SILS software 125 may be configured to perform a simulation not only using the virtual ECU 127 but also virtually reproducing a vehicle model or engine model.

The inputter 130 according to the embodiment may be configured to receive a user input. For example, the inputter 130 may be configured to receive a selection of a test scenario of a simulation from a user, and may be configured to receive an input regarding whether to perform a simulation, display of a simulation result, and the like. To this end, the inputter 130 may be provided as an input device generally known in the art.

The controller 140 according to the exemplary embodiment may be configured to control to perform a simulation using at least one of the HILS module 110 or the SILS software 125.

That is, the controller 140 may be configured to control at least one of the HILS module 110 or the SILS software 125 in order to perform a simulation on a network composed of at least one of the ECU 117 or the virtual ECU 127.

According to an embodiment, the controller 140 may be configured to configure a network based on a user input received through the inputter 130.

Specifically, the controller 140 may be configured to, when an input to perform a test on input/output electrical signals of a network is received, control the HILS module 110 to perform a simulation on a network including only the ECU 117.

In addition, the controller 140 may be configured to, when an input to perform a test on control logics of a network, control the SILS software 125 to perform a simulation on a network including only the virtual ECU 127.

In addition, the controller 140 according to an exemplary embodiment may be configured to control the HILS module 110 and the SILS software 125 to interwork to perform a simulation. For example, when a replacement evaluation of some ECU 117 or 127 is required, the controller 140 may be configured to control the HILS module 110 and the SILS software 125 to interwork to perform a simulation.

Specifically, the controller 140 may be configured to configure a network in which at least one of the ECUs 117 is replaced with the virtual ECU 127 using the communication interface 150, and may be configured to control both the HILS module 110 and the SILS software 125 in order to perform a simulation on the configured network.

That is, the controller 140 may be configured to configure a network, including at least one of the ECUs 117 of the HILS module 110 and at least one of the virtual ECUs 127 of the SILS software 125, through the communication interface 150.

In other words, at least one of the ECUs 117 of the HILS module 110 and at least one of the virtual ECUs 127 of the SILS software 125 may be configured to perform a controller area network (CAN) communication through the communication interface 150 to constitute a network. However, the communication protocol may not be limited to the above example, and any communication protocol capable of configuring a network may be applied without limitation.

For example, an ECU_A 117a of the HILS module 110 may be replaced with the virtual ECU_A 127a of the SILS software 125 so that the virtual ECU_A 127a, an ECU_B 117b, and an ECU_C 117c may constitute one network to be subject to a simulation.

The controller 140 may be configured to control the HILS module 110 to turn on the power of an ECU included in the network among the ECUs 117, and may be configured to control the SILS software 125 to turn on the switch of a virtual ECU included in the network among the virtual ECUs 127.

Conversely, the controller 140 may be configured to control the HILS module 110 to turn off the power of an ECU that is not included in the network among the ECUs 117, and may be configured to control the SILS software 125 to turn off the switch of a virtual ECU that is not included in the network among the virtual ECUs 127.

For example, when the virtual ECU_A 127a, the ECU_B 117b, and the ECU_C 117c constitute one network, the controller 140 may be configured to control the HILS module 110 to turn on the power of each of the ECU_B 117b and the ECU_C 117c and turn off the power of the ECU_A 117a. In addition, the controller 140 may be configured to control the SILS software 125 to turn on the switch of the virtual ECU_A 127a and turn off the switch of each of the virtual ECU_B 127b and the virtual ECU_C 127c,

In addition, when the controller 140 controls the HILS module 110 and the SILS software 125 to interwork to perform a simulation, the controller 140 may be configured to control the signal generator 160 to generate an electrical signal based on a virtual output of the virtual ECU 127 included in the network and to transmit the electrical signal to the ECU 117 included in the network.

In addition, the controller 140 may be configured to transmit and receive data to and from the HILS module 110 based on an electrical signal, and may be configured to transmit and receive data to and from the SILS software 125 based on a virtual signal. In this case, the virtual signal (input/output) may be a data signal in a virtual environment not through a H/wire, and the electrical signal may correspond to a signal transmitted by electrical connection through a H/wire or other wires.

The controller 140 may be configured to determine a simulation result based on at least one of the electrical signal received from the HILS module 110 or the virtual signal received from the SILS software, and may be configured to control the display 170 to output the simulation result.

The controller 140 may include at least one memory in which a program for performing the above-described operations and operations to be described below is stored, and at least one processor for executing the stored program. When the memory and the processor are plural, the memories and the processors may be integrated into one chip or may be provided in physically separate locations.

The communication interface 150 according to the embodiment may be configured to perform communication between the HILS module 110 and the SILS software 125. That is, the communication interface 150 may be configured to support communication between the ECU 117 of the HILS module 110 and the virtual ECU 127 of the SILS software 125, and may be configured to allow the ECU of the HILS module 110 and the virtual ECU 127 of the SILS software 125 to constitute a network.

For example, the communication interface 150 may be configured to support CAN communication between the ECU 117 and the virtual ECU 127. However, the communication protocol may not be limited to the above example as long as it can configure a network without limitation. To this end, the communication interface 150 may be provided as a communication module supporting the corresponding communication protocol.

In other words, the communication interface 150 may be configured to support data communication between the ECU 117 and the virtual ECU 127 so that the ECU 117 and the virtual ECU 127 constitute a single vehicle network.

The signal generator 160 according to the exemplary embodiment may be configured to generate an electrical signal based on the virtual output of the virtual ECU 127 and transmit the generated electrical signal to the ECU 117. To this end, the signal generator 160 may be provided as a signal generator generally known in the art.

That is, the signal generator 160 may be configured to, based on an instruction of the virtual output of the virtual ECU 127 that the ECU 117 should be supplied with an electrical signal, in a situation in which the ECU 117 and the virtual ECU 127 constitute one network through the communication interface 150, generate an electrical signal and supply the ECU 117 with the generated electrical signal.

For example, when an integrated body control unit (IBU) is provided as the virtual ECU 127, and the virtual ECU 127 corresponding to the IBU outputs a virtual signal corresponding to ACC, IG1, or IG2, the signal generator 160 may be configured to generate an electrical signal (power) corresponding to ACC, IG1, or IG2 and supply the electrical signal to the ECU 117 inside the HILS module 110.

The display 170 according to the embodiment may be configured to display a simulation result, and to this end, may be provided with a display module generally known in the art.

In the above, each component of the simulation device 100 according to the exemplary embodiment has been described. Hereinafter, a case in which the simulation device 100 performs a simulation will be described in detail.

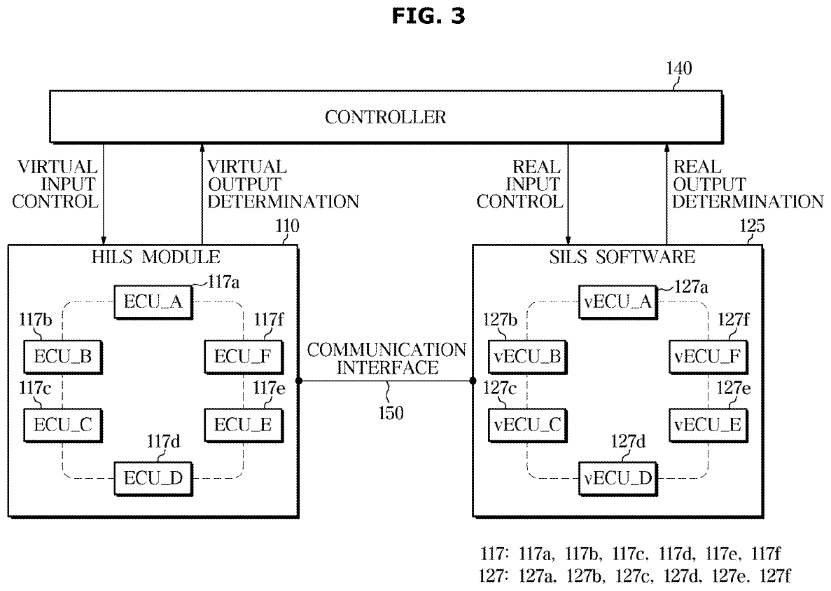

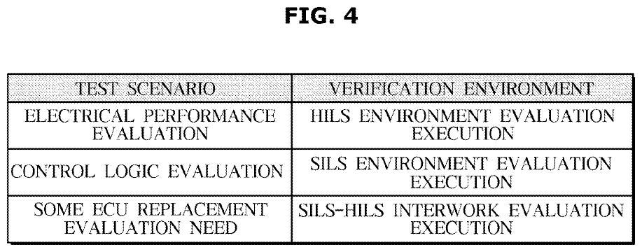

FIG. 3 illustrates an example of a configuration of a hardware in the loop simulation (HILS) module and software in the loop simulation (SILS) software according to an exemplary embodiment, and FIG. 4 is a diagram for describing a case in which the simulation device according to the exemplary embodiment performs a simulation according to a test scenario.

Referring to FIG. 3, the HILS module 110 according to the exemplary embodiment may be configured to include a plurality of ECUs 117 (117a, 117b, 117c, 117d, 117e, and 117f) and the SILS software 125 may be configured to include a plurality of virtual ECUs 127 (127a, 127b, 127c, 127d, 127e, and 127f. In the following description, the HILS module 110 and the SILS software 125 will be illustrated as having the above configuration. However, the number of ECUs 117 included in the HILS module 110 and the number of virtual ECUs 127 included in the SILS software 125 may be variously provided according to embodiments.

In this case, the controller 140 may be configured to transmit and receive data to and from the HILS module 110 based on an electrical signal, and may be configured to transmit and receive data to and from the SILS software 125 based on a virtual signal. The virtual signal (input/output) may be a data signal in a virtual environment not through H/wire, and the electrical signal may correspond to a signal electrically connected through H/wire or other wires and mutually transmitted.

That is, the controller 140 may be configured to transmit and receive data to and from the HILS module 110 based on an electrical signal required for control of the actual ECU. That is, the controller 140 may be configured to communicate with the HILS module 110 in the form of actual input/outputs generated through the simulator.

In addition, the controller 140 may be configured to transmit and receive data to and from the SILS software 125 based on a virtual signal required for control of the virtual ECU.

The communication interface 150 may be configured to support data transmission/reception between the ECU 117 of the HILS module 110 and the virtual ECU 127 of the SILS software 125.

According to an exemplary embodiment, the controller 140 may be configured to configure a network based on a user input received through the inputter 130.

Specifically, as shown in FIG. 4, the controller 140 may be configured to, upon receiving an input regarding a test on input/output electrical signals of a network (an evaluation of electrical performance), control the HILS module 110 to perform a simulation on a network including only the ECU 117 (an execution of a HILS environment evaluation).

That is, the simulation device 100 may be configured to, in the case of a test requiring electrical performance verification, such as identifying an input to the ECU 117 or checking load driving, configure a network only with a plurality of ECUs 117a, 117b, 117c, 117d, 117e, and 117f and control the HILS module 110 to perform a simulation.

In addition, as shown in FIG. 4, the controller 140 may be configured to, upon receiving an input regarding a test on control logics of a network (an evaluation of control logics), control the SILS software 125 to perform a simulation on a network including only the virtual ECU 127 (an execution of a SILS environment evaluation).

That is, the simulation device 100 may be configured to, in the case of a test only for checking control logics, such as verifying an occurrence of a bug, through software code execution, configure a network only with a plurality of virtual ECUs 127a, 127b, 127c, 127d, 127e and 127f and control the SILS software 125 to perform a simulation. In this case, the SILS software 125 may be configured to repeatedly perform the simulations for each option (region option, user setting option, startup type, etc.) or simultaneously perform the simulations for each option.

The simulation device 100 may be configured to control each of the HILS module 110 and the SILS software 125 to independently perform a simulation according to an embodiment. Specifically, the HILS module 110 may be configured to configure a network only with a plurality of ECUs 117a, 117b, 117c, 117d, 117e, and 117f to perform a simulation, and also the SILS software 125 may be configured to configure a network only with a plurality of virtual ECUs 127a, 127b, 127c, 127d, 127e, and 127f to perform a simulation.

In addition, the controller 140 according to an exemplary embodiment may be configured to control the HILS module 110 and the SILS software 125 to interwork to perform a simulation. For example, as shown in FIG. 4, the controller 140 may be configured to, when a replacement evaluation of some ECU 117 or 127 is required (requirement of replacement evaluation of some ECU), control the HILS module 110 and the SILS software 125 to interwork to perform a simulation (an execution of SILS-HILS interworking evaluation).

For example, the simulation device 100 may be configured to, in a situation of simulating using the HILS module 110, when a software update code of a specific ECU 117 is distributed but hardware development is delayed, replace the specific ECU 117 with a virtual ECU 127, and perform the simulation using both the HILS module 110 and the SILS software 125.

In addition, the simulation device 100 may be configured to, in a situation of simulating using the HILS module 110, when a new ECU is added and the corresponding software is distributed, add a virtual ECU corresponding to the new ECU, and perform the simulation using both the HILS module 110 and the SILS software 125.

In addition, the simulation device 100 may be configured to, in a situation of simulating using the SILS software 125, when hardware characteristic verification for a specific virtual ECU 127 is required, replace the specific virtual ECU 127 with a physical ECU 117, and perform the simulation using both the HILS module 110 and the SILS software 125.

Hereinafter, a simulation through interworking of the HILS module 110 and the SILS software 125 will be described in detail.

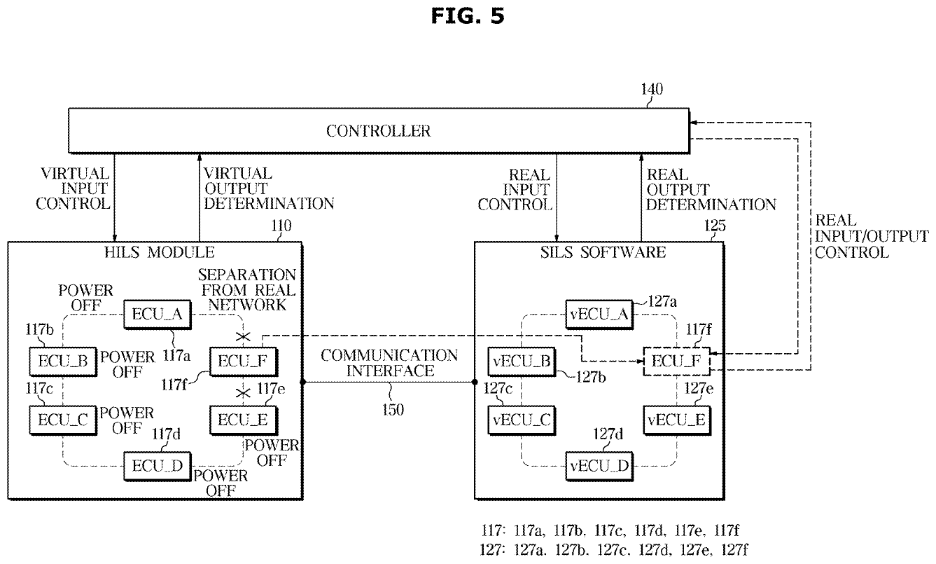

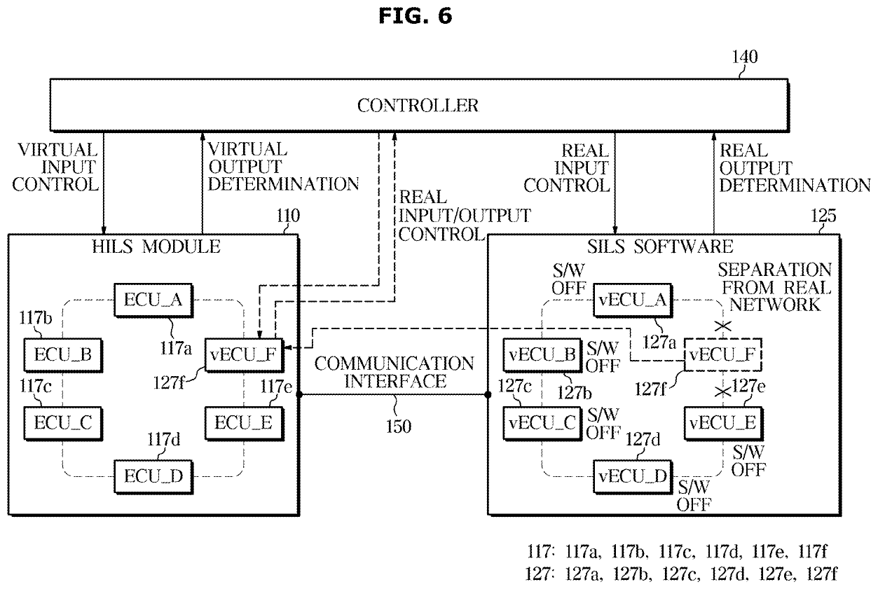

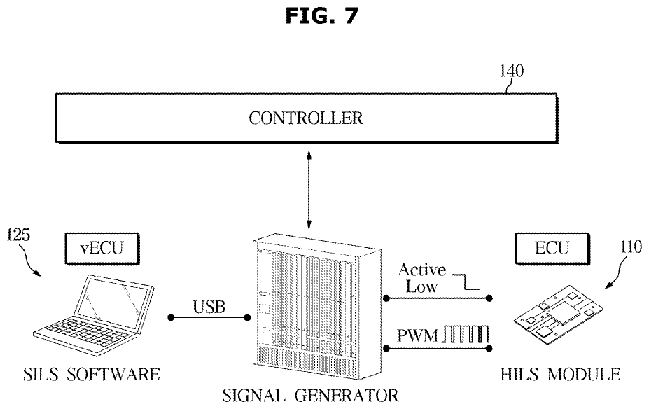

FIG. 5 illustrates an example of a network when the simulation device 100 according to the exemplary embodiment performs SILS-HILS interworking evaluation based on the SILS software 125, FIG. 6 illustrates an example of a network when the simulation device 100 according to the exemplary embodiment performs SILS-HILS interworking evaluation based on the HILS module 110, and FIG. 7 illustrates a case in which the simulation device 100 according to the exemplary embodiment controls the signal generator 160.

Referring to FIG. 5, the simulation device 100 according to the embodiment may be configured to configure a network in which at least one of the virtual ECUs 127 is replaced with an ECU 117 using the communication interface 150, and may be configured to control both the HILS module 110 and the SILS software 125 to perform a simulation on the configured network.

For example, when there is a need to verify hardware characteristics of a specific virtual ECU 127 in a situation of simulating using the SILS software 125, the virtual ECU 127 may be replaced with a physical ECU 117, and the simulation may be performed using both the HILS module 110 and the SILS software 125.

As shown in FIG. 5, the simulation device 100 may be configured to configure a network in which a virtual ECU_F 127f among a plurality of virtual ECUs 127a, 127b, 127c, 127d, 127e, and 127f of the SILS software 125 is replaced with an ECU_F 117f of the HILS module 110. In this case, the ECU_F 117f corresponds to the virtual ECU_F 127f, and may represent a physical ECU corresponding to the virtual ECU_F 127f.

That is, the virtual ECU_A 127a, the virtual ECU_B 127b, the virtual ECU_C 127c, the virtual ECU_D 127d, the virtual ECU_E 127e, and the ECU_F 117f may constitute a single network through the communication interface 150.

In this case, the simulation device 100 may be configured to control the HILS module 110 to turn on the power of only the ECU_F 117f among the plurality of ECUs 117 included in the HILS module 110, and may be configured to control the SILS software 125 to turn off the switch of only the virtual ECU_F 127f among the plurality of virtual ECUs 127 included in the SILS software 125.

The simulation device 100 may be configured to control the remaining virtual ECUs 127a, 127b, 127c, 127d, and 127e except for the virtual ECU_F 127f through the existing virtual input/outputs, and may be configured to control the ECU_F 117f through an electrical signal input/output.

Referring to FIG. 6, the simulation device 100 according to the embodiment may be configured to configure a network in which at least one of the ECUs 117 is replaced with a virtual ECU 127 using the communication interface 150, and may be configured to control both the HILS module 110 and the SILS software 125 to perform a simulation on the configured network.

For example, the simulation device 100 may be configured to, in a situation of simulating using the HILS module 110, when a software update code of a specific ECU 117 is distributed but hardware development is delayed, replace the specific ECU 117 with a virtual ECU 127, and perform the simulation using both the HILS module 110 and the SILS software 125.

In addition, the simulation device 100 may be configured to, in a situation of simulating using the HILS module 110, when a new ECU is added and the corresponding software is distributed, add a virtual ECU corresponding to the new ECU and perform the simulation using both the HILS module 110 and the SILS software 125.

As shown in FIG. 6, the simulation device 100 may be configured to configure a network in which an ECU_F 117f among a plurality of ECUs 117a, 117b, 117c, 117d, 117e, and 117f of the HILS module 110 is replaced with a virtual ECU_F 127f of the SILS software 125. In this case, the ECU_F 117f corresponds to the virtual ECU_F 127f, and may represent a physical ECU corresponding to the virtual ECU_F 127f.

That is, the ECU_A 117a, the ECU_B 117b, the ECU_C 117c, the ECU_D 117d, the ECU_E 117e, and the virtual electronic control F 127f may constitute a single network through the communication interface 150.

In this case, the simulation device 100 may be configured to control the HILS module 110 to turn off the power of only the ECU_F 117f among the plurality of ECUs 117 included in the HILS module 110 and control the SILS software 125 to turn on the switch of only the virtual ECU_F 127f among the plurality of virtual ECUs 127 included in the SILS software 125.

The simulation device 100 may be configured to control only the remaining ECUs 117a, 117b, 117c, 117d, and 117e except for the ECU_F 117f through the existing electrical signal input/outputs, and may control the virtual ECU_F 127f through a virtual signal input/output.

In addition, referring to FIG. 7, the controller 140 may be configured to, in the controlling of the HILS module 110 and the SILS software 125 to interwork to perform a simulation, control the signal generator 160 to generate an electrical signal based on a virtual output of the virtual ECU 127 included in the network and transmit the generated electrical signal to the ECU 117 included in the network.

The signal generator 160 may be configured to generate the electrical signal based on the virtual output of the virtual ECU 127 and may be configured to transmit the electrical signal to the ECU 117. To this end, the signal generator 160 may be provided as a signal generator generally known in the art.

That is, the signal generator 160 may be configured to, based on an instruction of the virtual output of the virtual ECU 127 that the ECU 117 should be supplied with an electrical signal, in a situation in which the ECU 117 and the virtual ECU 127 constitute one network through the communication interface 150, generate an electrical signal and supply the ECU 117 with the generated electrical signal.

For example, when an IBU is provided as the virtual ECU 127, and the virtual ECU 127 corresponding to the IBU outputs a virtual signal corresponding to ACC, IG1, or IG2, the signal generator 160 may be configured to generate an electrical signal (power) corresponding to ACC, IG1, or IG2 and supply the electrical signal to the ECU 117 inside the HILS module 110.

Hereinafter, an embodiment of a method of controlling a simulation device 100 according to an aspect will be described. The simulation device 100 according to the above-described exemplary embodiment may be used for the method of controlling the simulation device 100. Accordingly, the contents described above with reference to FIGS. 1 to 7 may be equally applied to the method of controlling the simulation device 100.

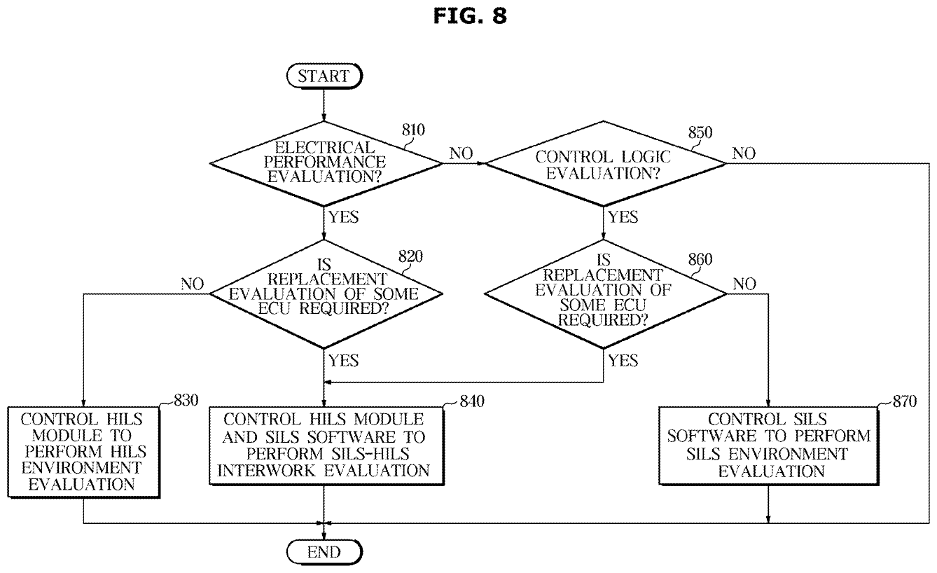

FIG. 8 is a flowchart showing a case in which a simulation may be performed based on a test scenario in a method of controlling a simulation device 100 according to an embodiment.

Referring to FIG. 8, the simulation device 100 according to the embodiment may be configured to, when an electrical performance evaluation is required (YES in operation 810) while replacement evaluation of some ECU is not required (NO in operation 820), control the HILS module 110 to perform HILS environment evaluation (830).

The controller 140 may be configured to, upon receiving an input regarding a test on input/output electrical signals of a network (evaluation of electrical performance), control the HILS module 110 to perform a simulation on a network including only the ECU 117 (an execution of HILS environment evaluation).

That is, the simulation device 100 may be configured to, in the case of a test requiring electrical performance verification, such as identifying an input to the ECU 117 or checking load driving, configure a network only with a plurality of ECUs 117a, 117b, 117c, 117d, 117e, and 117f and control the HILS module 110 to perform a simulation.

In addition, the simulation device 100 according to the exemplary embodiment may be configured to, in the case of an electrical performance evaluation (YES in operation 810) while replacement evaluation of some ECU is required (YES in operation 820), control the HILS module 110 and the SILS software 125 to perform SILS-HILS interwork evaluation (840).

That is, the controller 140 according to an exemplary embodiment may be configured to control the HILS module 110 and the SILS software 125 to interwork to perform a simulation. For example, as shown in FIG. 4, when a replacement evaluation of some ECU 117 is required (requirement of replacement evaluation of some ECU), the controller 140 may be configured to control the HILS module 110 and the SILS software 125 to interwork to perform a simulation (an execution of SILS-HILS interwork evaluation).

For example, the simulation device 100 may be configured to, in a situation of simulating using the HILS module 110, when a software update code of a specific ECU 117 is distributed but hardware development is delayed, replace the specific ECU 117 with a virtual ECU 127, and perform the simulation using both the HILS module 110 and the SILS software 125.

In addition, the simulation device 100 may be configured to, in a situation of simulating using the HILS module 110, when a new ECU is added and the corresponding software is distributed, add a virtual ECU corresponding to the new ECU, and perform the simulation using both the HILS module 110 and the SILS software 125.

The simulation device 100 according to the exemplary embodiment may be configured to, in the case of a control logic evaluation (YES in operation 850) rather than an electrical performance evaluation (NO in operation 810) while replacement evaluation of some ECU is not required (NO in operation 860), control the SILS software 125 to perform SILS environment evaluation (870).

The controller 140 may be configured to, upon receiving an input regarding a test on control logics of a network (an evaluation of control logics), control the SILS software 125 to perform a simulation on a network including only the virtual ECU 127 (an execution of SILS environment evaluation).

That is, the simulation device 100 may be configured to, in the case of a test only for checking control logics, such as verifying an occurrence of a bug through software code execution, configure a network only with a plurality of virtual ECUs 127a, 127b, 127c, 127d, 127e and 127f and control the SILS software 125 to perform a simulation. In this case, the SILS software 125 may be configured to repeatedly perform the simulations for each option (region option, user setting option, startup type, etc.) or may be configured to simultaneously perform the simulations for each option.

In addition, the simulation device 100 according to the exemplary embodiment may be configured to, in the case of control logic evaluation (YES in operation 850) rather than an electrical performance evaluation (NO in operation 810) while replacement evaluation of some ECU is required (YES in operation 860), control the HILS module 110 and the SILS software 125 to perform SILS-HILS interwork evaluation (840).

That is, the controller 140 according to an embodiment may be configured to control the HILS module 110 and the SILS software 125 to interwork to perform a simulation. For example, as shown in FIG. 4, when a replacement evaluation of some virtual ECU 127 is required (requirement of replacement evaluation of some ECU), the controller 140 may be configured to control the HILS module 110 and the SILS software 125 to interwork to perform a simulation (an execution of SILS-HILS interwork evaluation).

For example, the simulation device 100 may be configured to, in a situation of simulating using the SILS software 125, when hardware characteristic verification for a specific virtual ECU 127 is required, replace the specific virtual ECU 127 with a physical ECU 117, and perform the simulation using both the HILS module 110 and the SILS software 125.

Meanwhile, the disclosed embodiments may be embodied in the form of a recording medium storing instructions executable by a computer. The instructions may be stored in the form of program code and, when executed by a processor, may be configured to generate a program module to perform the operations of the disclosed embodiments. The recording medium may be embodied as a computer-readable recording medium.

The computer-readable recording medium may comprise some or all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, the simulation device and the method of controlling the same may perform simulation by interworking a hardware in the loop simulation (HILS) module using a physical ECU (ECU) and software in the loop simulation (SILS) software using a virtual ECU, so that control function verification of a vehicle system level may be flexibly performed, and the time taken for verification environment establishment and evaluation may be reduced.

Although embodiments of the present disclosure have been described for illustrative purposes, those skilled in the art will appreciate that various modifications, additions and substitutions are possible, without departing from the scope and spirit of the disclosure. Therefore, embodiments of the present disclosure have not been described for limiting purposes.

What is claimed is:

1. A simulation device comprising:
a hardware in the loop simulation (HILS) module comprising one or more electronic control units (ECUs);
a storage configured to store a software in the loop simulation (SILS) software comprising one or more virtual ECUs; and
a controller configured to control at least one of the HILS module or the SILS software to perform a simulation on a network comprising at least one of the ECU or the virtual ECU.

2. The simulation device of claim 1, further comprising a communication interface configured to perform communication between the HILS module and the SILS software.

3. The simulation device of claim 2, further comprising a signal generator configured to generate an electrical signal based on a virtual output of a virtual ECU, of the one or more virtual ECUs, and transmit the electrical signal to an ECU, of the one or more ECUs.

4. The simulation device of claim 3, wherein the controller is further configured to:
configure a network in which at least one of the ECUs is replaced with a virtual ECU, of the one or more virtual ECUs, using the communication interface; and
control both the HILS module and the SILS software to perform a simulation on the configured network.

5. The simulation device of claim 4, wherein the controller is further configured to:
control the HILS module to turn on power of an ECU included in the configured network, among the one or more ECUs; and
control the SILS software to turn on a switch of a virtual ECU included in the configured network, among the one or more virtual ECUs.

6. The simulation device of claim 1, further comprising an inputter configured to receive a user input,
wherein the controller is further configured to configure a network based on the user input received through the inputter.

7. The simulation device of claim 6, wherein the controller is further configured to, when an input to perform a test on input/output electrical signals of a network is received, control the HILS module to perform a simulation on a network comprising only the one or more ECUs.

8. The simulation device of claim 6, wherein the controller is further configured to, when an input to perform a test on control logics of a network, control the SILS software to perform a simulation on a network comprising only the one or more virtual ECUs.

9. The simulation device of claim 1, wherein the controller is further configured to:
transmit and receive data to and from the HILS module, based on an electrical signal;
transmit and receive data to and from the SILS software, based on a virtual signal; and
determine a result of the simulation based on at least one of the electrical signal received from the HILS module or the virtual signal received from the SILS software.

10. The simulation device of claim 9, comprising a display, wherein the controller is further configured to control the display to display the result of the simulation.

11. A method of controlling a simulation device comprising a hardware in the loop simulation (HILS) module comprising an electronic control unit (ECU) and a storage configured to store a software in the loop simulation (SILS) module comprising a virtual ECU, the method comprising:
controlling at least one of the HILS module or the SILS module to perform a simulation on a network comprising at least one of the ECU or the virtual ECU.

12. The method of claim 11, wherein the simulation device further comprises a communication interface configured to perform communication between the HILS module and the SILS software.

13. The method of claim 12, wherein the simulation device further comprises a signal generator configured to:
generate an electrical signal based on a virtual output of the virtual ECU; and
transmit the electrical signal to the ECU.

14. The method of claim 13, wherein the controlling of the at least one of the HILS module or the SILS software further comprises:
configuring a network in which at least one of the ECUs is replaced with the virtual ECU using the communication interface; and
controlling both the HILS module and the SILS software to perform a simulation on the configured network.

15. The method of claim 14, wherein the controlling of the at least one of the HILS module or the SILS software further comprises:
controlling the HILS module to turn on power of an ECU included in the configured network among the ECUs; and
controlling the SILS software to turn on a switch of a virtual ECU included in the configured network among the virtual ECUs.

16. The method of claim 11, wherein:
the simulation device further comprises an inputter configured to receive a user input, and
the method further comprises configuring a network based on the user input received through the inputter.

17. The method of claim 16, wherein the controlling of the at least one of the HILS module or the SILS software further comprises, when an input to perform a test on input/output electrical signals of a network is received, controlling the HILS module to perform a simulation on a network comprising only the ECU.

18. The method of claim 16, wherein the controlling of the at least one of the HILS module or the SILS software further comprises, when an input to perform a test on control logics of a network, controlling the SILS software to perform a simulation on a network comprising only the virtual ECU.

19. The method of claim 11, further comprising:
transmitting and receiving data to and from the HILS module based on an electrical signal;
transmitting and receiving data to and from the SILS software based on a virtual signal; and
determining a result of the simulation based on at least one of the electrical signal received from the HILS module or the virtual signal received from the SILS software.

20. The method of claim 19, wherein:
the simulation device further comprises a display, and
the method further comprises controlling the display to display the result of the simulation.
